(19) United States
(12) Patent Application Publication
(10) Pub. No.: US 2008/0211329 A1
(43) Pub. Date: Sep. 4, 2008

(54) Electric motor

(76) Inventor: Martin Bauer, Villingen-Schwenningen (DE)

Correspondence Address: COOPER & DUNHAM, LLP, 1185 AVENUE OF THE AMERICAS, NEW YORK, NY, 10036, US

(21) Appl. No.: 12/069,680

(22) Filed: Feb. 12, 2008

(30) Foreign Application Priority Data
Mar. 1, 2007 (DE) 10 2007 009 996.6

(51) Int. Cl. H02K 5/02; H02K 5/16

(52) U.S. Cl. 310/51; 310/90

(57) ABSTRACT

The invention relates to an electric motor, particularly a spindle motor used for driving storage disks in hard disk drives, having a stationary bearing part (14), a shaft (16) rotatably supported in the stationary bearing part, a hub (18) connected to one end of the shaft and an electromagnetic drive system. The electric motor is characterized in that the hub (18) is at least partly made of a metal alloy having a high specific damping capacity.

### BACKGROUND OF THE INVENTION

The invention relates to an electric motor, particularly a spindle motor used for driving disk drives or a motor used for driving fans. The motor comprises a stationary bearing part, a shaft rotatably supported in the stationary bearing part, a hub connected to one end of the shaft and an electromagnetic drive system.

### PRIOR ART

Electric motors, particularly spindle motors of a conventional design, substantially comprise a stationary bearing part, a rotatably supported bearing part and at least one bearing system disposed between these two parts. Among other bearings, fluid dynamic bearing systems also find application as the bearing system.

A well-known embodiment of a spindle motor having a fluid dynamic bearing system is revealed in DE 102 39 650 B3. The bearing system comprises a shaft and a bearing bush that has an axial bore to receive the shaft. The shaft rotates freely in the stationary bearing bush and forms a fluid dynamic radial bearing together with the bearing bush. The mutually interacting bearing surfaces of the shaft and bearing bush are spaced apart from one another by a thin, concentric bearing gap filled with bearing fluid. The shaft carries a hub on which the storage disks, for example, of a hard disk drive are disposed. Displacement of the above-described arrangement along the rotational axis is prevented by appropriately designed fluid dynamic axial bearings. The fluid dynamic thrust bearings are preferably formed by the two end faces of a thrust plate, preferably but not necessarily, arranged at the end of the shaft, one of the end faces of the thrust plate being associated with a corresponding end face of the bearing bush and the other end face being associated with the inside end face of a cover. The cover forms a counter bearing to the thrust plate and seals the open end of the bearing system, preventing air from penetrating into the bearing gap filled with bearing fluid. In the illustrated bearing system, a liquid bearing fluid, such as a bearing oil, is used.

In many cases, the shaft and the hub are connected together using an interference fit or a bonded joint or by a combination of these two types of connection. A disadvantage of these connections is that the achievable connecting forces are not very large and any vibrations result in material deformations in the region of the joint, which are transferred to the storage disks disposed on the hub and may there lead to errors in the reading/writing of data. A further disadvantage is that the materials used, steel and aluminum, both show low damping behavior.

### SUMMARY OF THE INVENTION

It is thus the object of the invention to provide a motor, particularly a spindle motor, which shows an improvement in the damping behavior of the joint between the shaft and the hub.

This object has been achieved according to the invention by the characteristics outlined in claim 1.

Preferred embodiments and further developments of the invention are the subject matter of the subordinate claims.

A motor is proposed that has a stationary bearing part, a shaft rotatably supported in the stationary bearing part, a hub connected to one end of the shaft and an electromagnetic drive system. According to the invention the hub is made of a metal alloy at least in the region of the joint to the shaft, the metal alloy having a high specific damping capacity under the given operating conditions, particularly the specified temperature range and the vibration frequencies and amplitudes that occur. Since the greatest vibration-related deformations occur in this region of the joint between the shaft and hub, it is in this region that the highest level of damping is most effective.

In a preferred embodiment of the invention, the hub may consist of a first and a second part, only the first part connected to the shaft being made of the metal alloy having a high damping capacity. The second part of the hub may be made of aluminum or steel in a conventional manner.

It is preferable if the damping capacity of the metal alloy is considerably greater than the damping capacity of aluminum or steel, and it is preferably at least 10 times as great.

Particularly suitable as metal alloys are alloys having mobile twin or phase boundaries. Alongside Sonoston, a manganese-copper alloy, Incramute (58 Cu, 40 Mn, 2 Al), Proteus (Cu—Zn—Al) and Nitinol (55Ni-45Ti), so-called shape memory alloys, particularly a copper-aluminum-manganese alloy called Maxidamp can also be considered. Maxidamp was developed in Germany by the Technical University of Clausthal and has a specific damping capacity of up to 80 percent. The loss tangent is tan δ=0.127 (see also DE 10 2005 035 709 A1).

The joint between the hub or the first part of the hub respectively and the shaft may be realized in a conventional manner using an interference fit, by bonding or (laser) welding or a combination of these three methods of joining.

### BRIEF DESCRIPTION OF THE DRAWINGS

FIG. 1: shows a cross section through a first embodiment of a spindle motor according to the invention used for driving a hard disk drive.

FIG. 2: shows a cross section through a second embodiment of a spindle motor according to the invention used for driving a hard disk drive.

FIG. 3: shows a cross section through a third embodiment of a spindle motor according to the invention used for driving a hard disk drive.

### DESCRIPTION OF PREFERRED EMBODIMENTS OF THE INVENTION

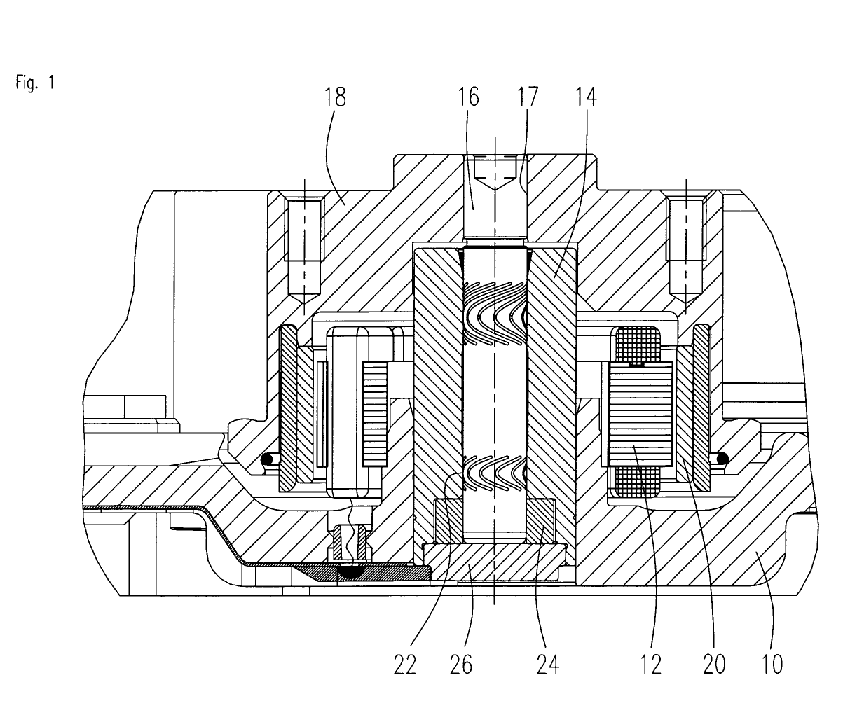

FIG. 1 shows a cross section through a first embodiment of a spindle motor according to the invention used for driving a hard disk drive. The spindle motor comprises a stationary baseplate 10 on which an annular stator arrangement 12 forming part of an electromagnetic drive system is disposed. A bearing bush 14 is fixed in a sleeve-shaped recess in the baseplate 10. The bearing bush 14 has a cylindrical axial bore in which a shaft 16 is rotatably accommodated.

The spindle motor comprises a fluid dynamic bearing arrangement. A bearing gap 22 filled with lubricant is defined between the inside diameter of the bearing bush 14 and the outside diameter of the shaft 16. The fluid dynamic bearing arrangement comprises two radial bearing regions that are marked by a surface pattern which is provided on the surface of the shaft 16 or of the bearing bush 14. As soon as the hub 18 is set in rotation, and thus the shaft 16 as well, fluid dynamic pressure is built up in the bearing gap 22 or in the lubricant found in the bearing gap due to the surface pattern, thus giving the bearing its load carrying capacity.

At the lower end of the shaft, a fluid dynamic thrust bearing is provided. The thrust bearing comprises a thrust plate 24 disposed at the lower end of the shaft and a counter plate 26 that closes the lower end of the bearing bush 14, preventing lubricant from escaping from the bearing gap 22. The thrust bearing absorbs the axial loads of the bearing arrangement. The counter plate 26 forms a counter bearing to the thrust plate 24. Both the thrust plate 24 and the counter plate 26 are accommodated in appropriate recesses in the bearing bush 14.

The free end of the shaft 16 carries a hub 18 on which one or more storage disks (not illustrated) of the hard disk drive are disposed and fixed. At the inner, lower rim of the hub 18, an annular permanent magnet 20 having a plurality of pole pairs is disposed, the permanent magnet 20 being located opposite the stator arrangement 12. The stator arrangement 12 is separated from the permanent magnet 20 by a working air gap and an alternating electric field is applied to the stator arrangement, thus setting the rotor of the motor, consisting of the hub 18 and the shaft 16, in rotation.

According to the invention, the hub 18 is made of a casting material taking the form of a metal alloy having a high specific damping capacity. The metal alloy is preferably a manganese-copper alloy (Sonoston) or a copper-aluminum-manganese alloy that is also known as Maxidamp. The copper-aluminum-manganese alloy is a shape memory alloy that transforms martensitically. The advantages of Maxidamp include the fact that its damping capacity can be adjusted to the relevant field of application and can reach as high as 80 percent. In comparison, aluminum only has a specific damping capacity of approximately 1 to 4 percent, depending on its strain. By decoupling the rotor magnet 20 and the hub 18 from the shaft 16, the vibrations transferred to the hub 18 and the noise emission of the motor are reduced. Furthermore it is possible to subject the surface 17 of the hub 18 to heat treatment, using laser beams or induction heating, so as to improve its damping properties.

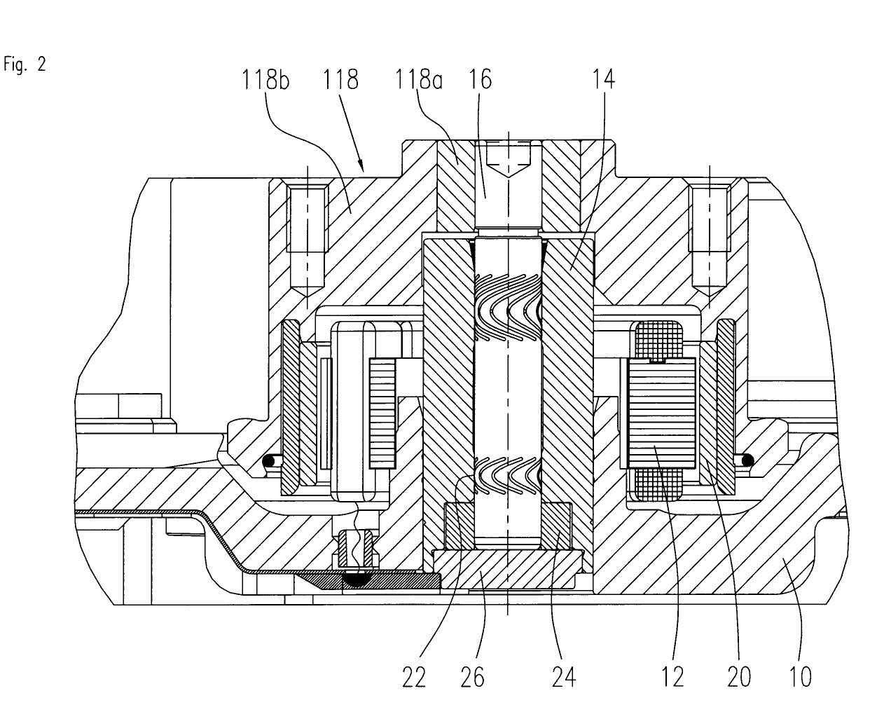

FIG. 2 shows a cross section through a second embodiment of a spindle motor according to the invention used for driving a hard disk drive. The spindle motor in FIG. 2 is almost identical to the spindle motor of FIG. 1, identical parts being indicated by the same reference numbers.

In contrast to FIG. 1, the hub 118 in FIG. 2 is formed as two pieces. The hub 118 comprises a first annular part 118a that is inserted in a bore in a second, bell-shaped part 118b. The first part 118a is connected to the shaft 16 and is made of a metal alloy having a high specific damping capacity, such as a copper-aluminum-manganese alloy, which is also known as Maxidamp. The second part 118b of the hub is made, for example, of aluminum or steel. Thanks to the damping properties of the material of the first part 118a of the hub, the remaining part 118b of the hub 118 is decoupled from the shaft 16. Thus vibrations transferred to the hub 118 and the noise emissions of the motor are reduced. The part 118a that is disposed between the shaft 16 and the hub 18 may be made merely of a thin layer or a coating of damping material.

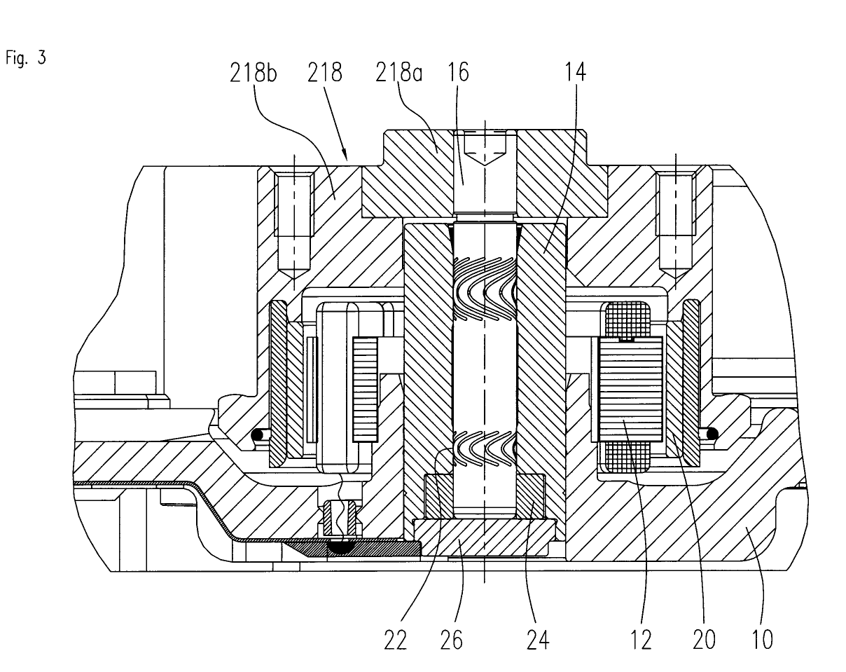

FIG. 3 shows a cross section through a third embodiment of a spindle motor according to the invention used for driving a hard disk drive. The spindle motor in FIG. 3 is almost identical to the spindle motor of FIG. 1, identical parts being indicated by the same reference numbers.

In contrast to FIG. 1, the hub 218 in FIG. 3 is formed as two pieces. The hub 218 comprises a first annular part 218a that is inserted into a stepped recess of a second, bell-shaped part 218b. The first part 218a is connected to the shaft 16 and is made of a metal alloy having a high specific damping capacity, such as a copper-aluminum-manganese alloy, which is also known as Maxidamp. The second part 218b of the hub is made, for example, of aluminum or steel. Thanks to the damping properties of the material of the first part 218a of the hub, the remaining part 118b of the hub 118 is decoupled from the shaft 16. Thus vibrations transferred to the hub 118 and the noise emissions of the motor are reduced.

### IDENTIFICATION REFERENCE LIST

10 Baseplate
12 Stator arrangement
14 Bearing bush
16 Shaft
17 Surface of the hub
18 Hub
20 Permanent magnet
22 Bearing gap
24 Thrust plate
26 Counter plate
118 Hub
118a First part of the hub
118b Second part of the hub
218 Hub
218a First part of the hub
218b Second part of the hub

1. An electric motor used particularly for driving fans or storage disks in hard disk drives having a stationary bearing part (14), a shaft rotatably supported in the stationary bearing part (16), a hub (18; 118; 218) connected to one end of the shaft and an electromagnetic drive system, characterized in that the hub (18; 118; 218) is at least partly made of a metal alloy having a high specific damping capacity.

2. An electric motor according to claim 1, characterized in that the hub (18; 118; 218) comprises a first (118a; 218a) and a second part (118b; 218b), the first part (118a; 218a) being connected to the shaft (16) and made of the metal alloy having a high specific damping capacity.

3. An electric motor according to claim 1, characterized in that a thin layer or coating is disposed between the hub (18) and the shaft (16) that is made of a metal alloy having a high specific damping capacity.

4. An electric motor according to claim 1, characterized in that the specific damping capacity of the metal alloy is at least 50%.

5. An electric motor according to claim 1, characterized in that the specific damping capacity of the metal alloy at least 10 times that of aluminum or steel.

6. An electric motor according to claim 1, characterized in that the metal alloy is a shape memory alloy.

7. An electric motor according to claim 1, characterized in that the metal alloy is a copper-aluminum-manganese alloy or a manganese-copper alloy.

8. An electric motor according to claim 2, characterized in that the second part (118b; 218b) of the hub (18; 118; 218) is made of aluminum or steel.

9. An electric motor according to claim 2, characterized in that the hub (18; 118; 218) or the first part (118a; 218a) of the hub is connected to the shaft (16) using an interference fit and/or by bonding and/or welding.
